(19) United States
(12) Patent Application Publication
(10) Pub. No.: US 2003/0200665 A1
(43) Pub. Date: Oct. 30, 2003

(54) Blade handle

(76) Inventor: Min Li, Indianapolis, IN (US)

Correspondence Address: BARNES & THORNBURG, 11 SOUTH MERIDIAN, INDIANAPOLIS, IN, 46204

(21) Appl. No.: 10/135,590

(22) Filed: Apr. 30, 2002

(51) Int. Cl. B26B 1/00

(52) U.S. Cl. 30/339; 30/329

(57) ABSTRACT

A blade handle for a surgical blade which allows the surgical blade to be easily removed therefrom is disclosed.

### FIELD OF THE INVENTION

The present invention relates to a blade handle, and more particularly to an ergonomically correct blade handle for a surgical blade which allows the surgical blade to be easily attached thereto and removed therefrom.

### BACKGROUND OF THE INVENTION

Conventional scalpels used in surgical procedures can include a blade attached to a flat or plate like a handle. Generally, scalpel blades utilized in surgical procedures are disposable. Accordingly, the blades are typically removed from the handle after the surgical procedure and discarded. Once the old blade has been removed and discarded, a new blade can be attached to the handle such that additional surgical procedures can be performed.

Unfortunately, the handle portion of conventional scalpels has several drawbacks. For example, it is difficult to remove and attach a blade to a conventional scalpel handle. The degree of difficulty in removing and attaching a blade to these handles can be so great as to require a blade grasping tool (e.g. a pair of hemostats) in order to accomplish the task. The aforementioned difficulty in removing and attaching a blade to a conventional handle can be dangerous to the patient and the surgical team, and is certainly an inconvenience.

Another example of a drawback conventional scalpel handles have is that, as mentioned above, they are configured to be flat or plate like. Having these handles configured in such a manner makes it difficult for surgeons to perform barrel incisions (i.e., circular or curved incisions). In particular, the flat or plate like configuration of the handle makes it difficult for the surgeon to utilize his or her fingers to smoothly rotate the handle around its longitudinal axis. Therefore, a barrel incision performed with a conventional scalpel handle is difficult and tedious to perform which can result in additional scarring.

What is needed therefore is a blade handle for a surgical blade which (i) allows the surgical blade to be easily attached and removed therefrom and (ii) enhances a surgeon's ability to perform circular or curved incisions.

### SUMMARY OF THE DISCLOSURE

In one illustrative embodiment, there is provided a blade handle which includes a handle body and a blade carrier member extending from an end of the handle body. The blade handle also includes a shoulder member extending from a surface of the blade carrier member. The blade handle further includes a ramp portion extending from the surface of the blade carrier member. The ramp portion has a leading ramp end and a trailing ramp end. The ramp portion is positioned on the surface so that the leading ramp end contacts the shoulder member.

In another exemplary embodiment, there is provided a blade handle. The blade handle includes a blade carrier member. The blade handle also includes a handle body having (i) a cylindrical gripping portion with a first end portion and a second end portion and (ii) a plate segment. The blade carrier member extends from the first end portion of the cylindrical gripping portion. The plate segment extends from the second end portion of the cylindrical gripping portion.

In yet another exemplary embodiment, there is provided a blade handle. The blade handle includes a cylindrical gripping portion having a first end portion and a second end portion. The blade handle also includes a blade carrier member attached to the first end portion of the cylindrical gripping portion. The blade carrier member has (i) a surface, (ii) a shoulder member extending outwardly from the surface, and (iii) a ramp portion extending outwardly from the surface. The ramp portion has a leading ramp end and a trailing ramp end. The ramp portion is positioned on the surface so that the leading ramp end contacts the shoulder member. The blade handle further includes a plate segment extending from the second end portion of the cylindrical gripping member.

The above and other objects, features, and advantages of the present invention will become apparent from the following description and the attached drawings.

### BRIEF DESCRIPTION OF THE DRAWINGS

FIG. 1 is a side elevational view of a blade handle;

FIG. 2 is another side elevational view of the blade handle of FIG. 1;

FIG. 3 is a top elevational view of the blade handle of FIG. 1;

FIG. 4 is an end elevational view of the blade handle of FIG. 1;

FIG. 5 is an enlarged fragmentary view of a the blade handle of FIG. 1 showing the blade carrier member thereof;

FIG. 6 is a view similar to FIG. 5, but showing an initial view of the process of attaching a surgical blade to the blade carrier member;

FIG. 7 is a view similar to FIG. 6, but showing a subsequent view of the process of attaching the surgical blade to the blade carrier member;

FIG. 8 is a view similar to FIG. 7, but showing the surgical blade attached to the blade carrier member;

FIG. 9 is a side elevational view of the blade handle of FIG. 1 with a surgical blade attached thereto being held by a hand of a surgeon;

FIG. 10 is a top elevational view of the blade handle of FIG. 9 being held by the hand of the surgeon;

FIG. 11 is a side elevational of a surgical blade which can be attached to the blade handle of FIG. 1;

FIG. 12 is an enlarged fragmentary view of a conventional blade handle showing an initial view of the process of attaching a surgical blade to the blade handle;

FIG. 13 is a view similar to FIG. 12, but showing a subsequent view of the process of attaching the surgical blade to the blade handle;

FIG. 14 is a view similar to FIG. 13, but showing a further subsequent view of the process of attaching the surgical blade to the blade handle; and

FIG. 15 is a view similar to FIG. 14 but showing the surgical blade attached to the blade handle.

### DETAILED DESCRIPTION OF ILLUSTRATIVE EMBODIMENTS

While the invention is susceptible to various modifications and alternative forms, specific exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

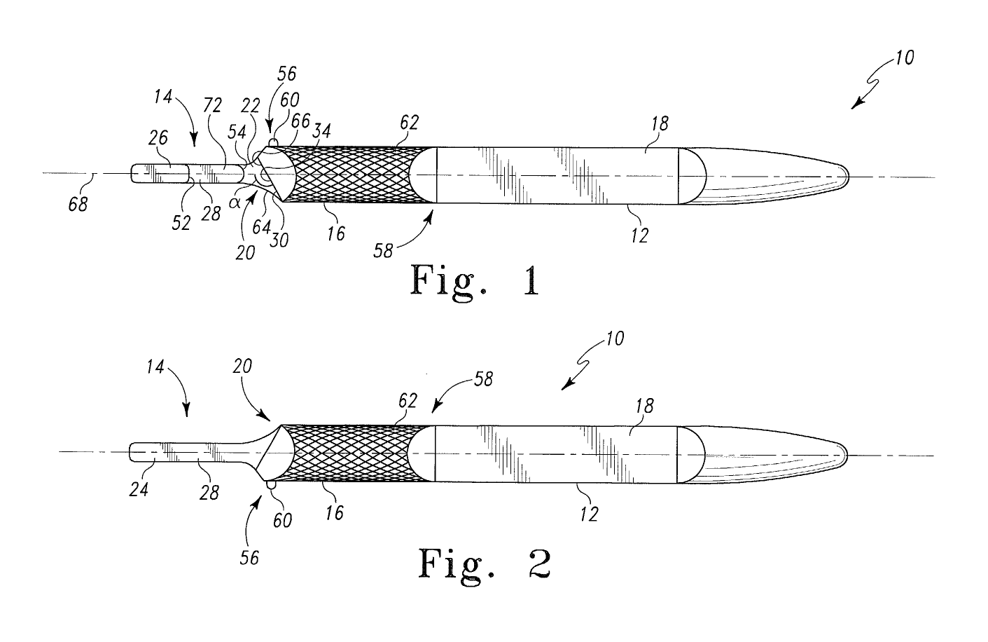

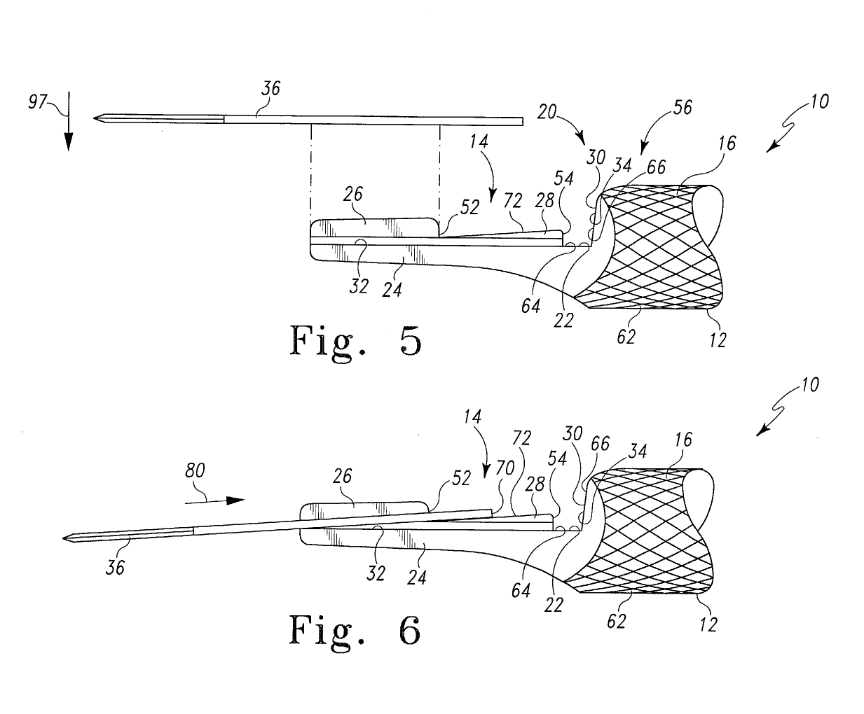

Referring now to FIGS. 1-5 there is shown a blade handle 10. Blade handle 10 includes a handle body 12 and a blade carrier member 14 extending from an end 20 of handle body 12. Blade handle 10 also includes a shoulder member 26 extending from a surface 22 of blade carrier member 14. Blade member 10 further includes a ramp portion 28 extending from surface 22 of blade carrier member 14. Ramp portion 28 has a leading ramp end 52, a trailing ramp end 54, and an inclined surface 72 (see FIG. 5) interposed between leading ramp end 52 and trailing ramp end 54. Ramp portion 28 is positioned on surface 22 of blade carrier member 14 so that leading ramp end 52 of ramp portion 28 contacts shoulder member 26. Note that inclined surface 72 is inclined away from surface 22 in a direction going from leading ramp end 52 to trailing ramp end 54 (see FIG. 5). Also note that having ramp portion 28 extend such that leading ramp end 52 of ramp portion 28 contacts shoulder member 26 results in inclined surface having a low slope.

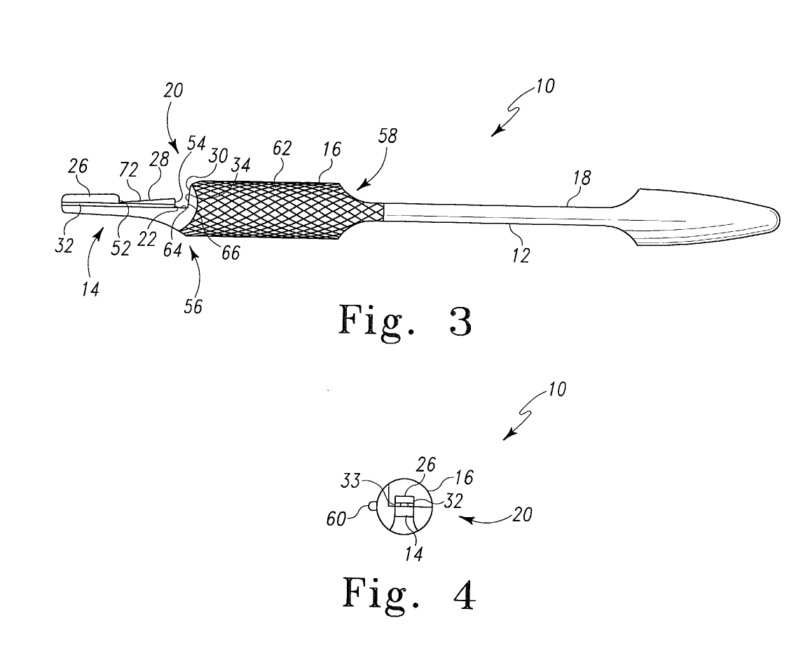

As shown in FIGS. 3, 4, and 5, a groove 32 is defined in a side of blade carrier member 14 such that groove 32 is interposed between shoulder member 26 and blade carrier member 14. Groove 32 is also interposed between ramp portion 28 and blade carrier member 14. As shown in FIG. 4, another groove 33 is defined in the opposite side of blade carrier member 14. Note that groove 33 is substantially identical to groove 32 and is interposed between shoulder member 26 and blade carrier member 14. Like groove 32, groove 33 is also interposed between ramp portion 28 and blade carrier member 14.

Now referring to FIGS. 1-3, handle body 12 includes a cylindrical gripping portion 16 and a plate segment 18. Cylindrical gripping portion 16 has a first end portion 56, a second end portion 58, and an outer surface 62. Blade carrier member 14 is attached to and extends from first end portion 56 of cylindrical gripping portion 16. Plate segment 18 is attached to and extends from second end portion 58 of cylindrical gripping portion 16. Preferably, outer surface 62 of cylindrical gripping portion 16 is textured so as enhance a surgeon's ability to grip handle body 12. In addition, it is preferable that a detent 60 is attached to an outer surface 62 of handle body 12 such that detent 60 extends outwardly therefrom and prevents blade handle 10 from rolling when placed on a flat surface.

As shown in FIGS. 1 and 5, a channel 30 is defined between trailing ramp end 54 and a wall segment 66 of a side wall 34 defined on first end portion 56 of cylindrical gripping portion 16. Note that wall segment 66 intersects a longitudinal axis 68 of handle body 12 so as to define an obtuse angle α therebetween (see FIG. 1). For example, obtuse angle α can be about 120°.

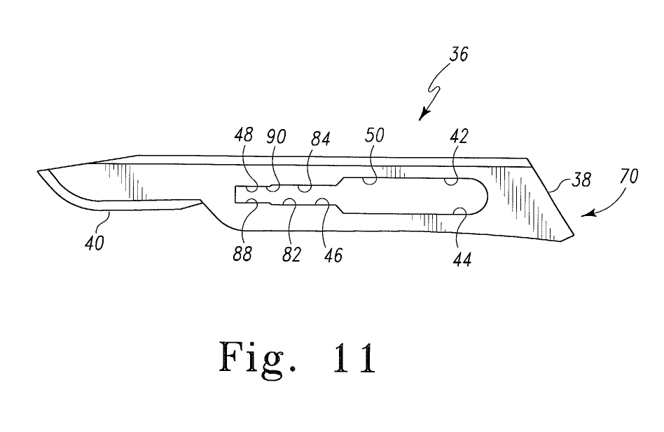

Referring now to FIG. 11, there is shown a blade 36 which can be attached to blade handle 10 so as to perform, for example, surgery. Blade 36 includes a leading edge 38 and a cutting edge 40. Blade 36 also has a receiving aperture 42 defined therein. Receiving aperture 42 is defined by aperture edge 50 and includes a leading aperture section 44, an intermediate aperture section 46, and a trailing aperture section 48.

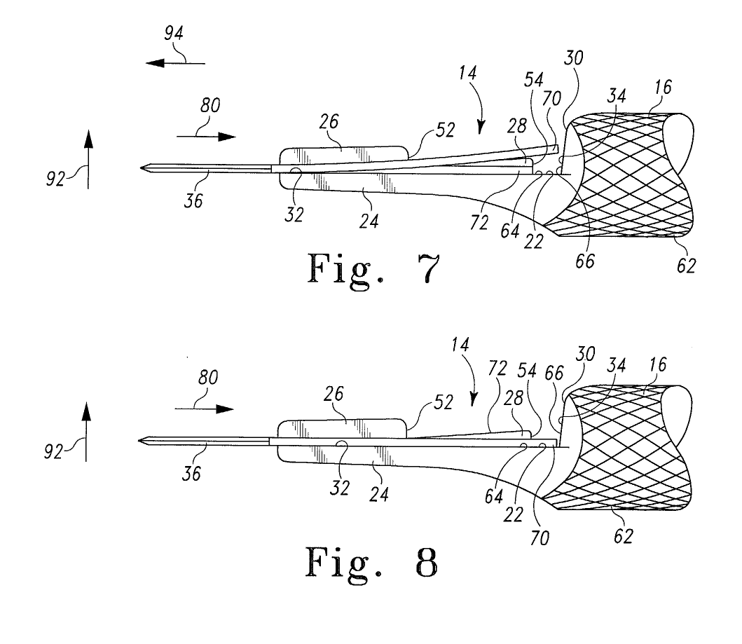

Referring now to FIGS. 5, 6, 7, and 8, blade 36 is attached to blade handle 10 in the following manner. Initially blade 36 is positioned relative to blade carrier member 14 as shown in FIG. 5. Blade 36 is then moved relative to blade carrier member 14 in the direction indicated by arrow 97 until shoulder member 26 is positioned within receiving aperture 42 as shown in FIG. 6. In particular, blade 36 is positioned relative to blade carrier member 14 so that (i) shoulder member 26 is positioned within leading aperture 44, (ii) a portion of aperture edge 50 is located within groove 32, and (iii) another portion of aperture edge 50 is located within groove 33. Positioning blade 36 in the above described manner results in an end 70 of blade 36 being positioned in contact with inclined surface 72 of ramp portion 28. Note that at this point in the attachment process, i.e. having shoulder member 26 positioned within leading aperture 44 and end 70 of blade 36 in contact with inclined surface 72. Also note that blade 36 is not significantly bent or flexed as a result of being in contact with inclined surface 72. This is due to inclined surface 72 having a relatively low slope.

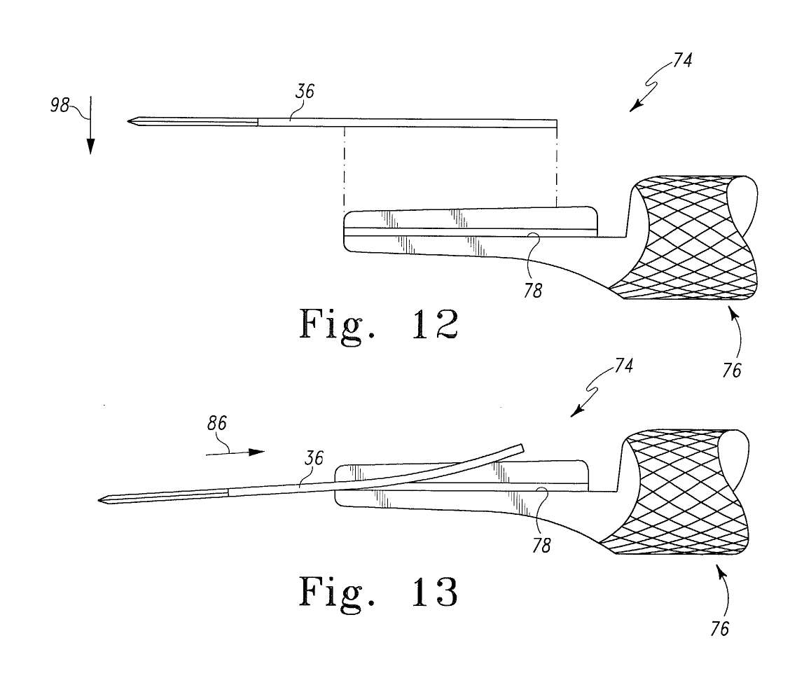

It should be appreciated that not having blade 36 significantly flexed or bent at this point makes it easier to attach blade 36 to blade handle 10 since blade 36 is easily moved or manipulated when in this state. This is in contrast to other conventional blade handles which require the blade to be somewhat flexed when initially attaching the blade to an attachment member the conventional blade handle. For example, as shown in FIG. 12, blade 36 is initially moved toward a conventional blade attachment member 74 in the direction indicated by arrow 98. As shown in FIG. 13, when blade 36 is initially engaged with blade attachment member 74 of a conventional blade handle 76 it must be somewhat bent or flexed in order to have aperture edge 50 of blade 36 properly seated within grooves 78 (note only one groove 78 is shown in FIG. 13) defined in attachment member 74. Having blade 36 flexed or bent to this degree results in blade 36 being urged against attachment member 74, and thus makes it relatively difficult to move or manipulate blade 36 relative to conventional blade handle 76. Accordingly, it is more difficult to initially engage blade 36 with attachment member 74 of conventional blade handle 76 as compared to initially engaging blade 36 with blade carrier member 14 of blade handle 10.

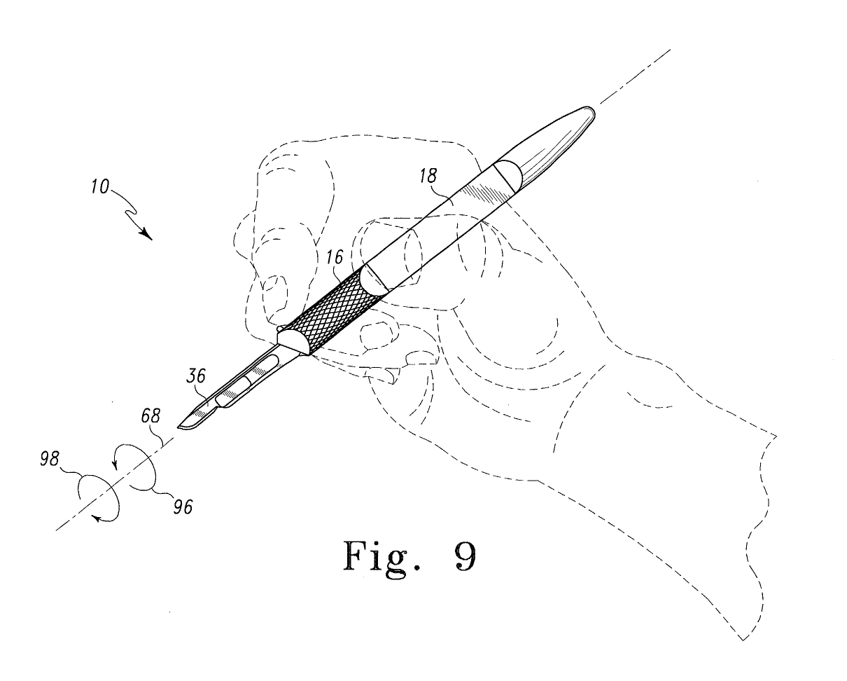

Referring now to FIG. 7, after initially engaging blade 36 with blade carrier member 14 (see FIG. 6), blade 36 is moved relative to blade handle 10 in the direction indicated by arrow 80 until intermediate aperture edges 82 and 84 (see FIG. 11) are positioned with in grooves 32 and 33, respectively. Moving blade 36 in the direction indicted by arrow 80 results in end 70 of blade 36 being advanced up surface 72 of ramp portion 28 in the direction of trailing ramp end 54. Advancing end 70 of blade 36 up surface 72 results in blade 36 being flexed or bent as blade 36 moves up surface 72. However, it should be appreciated that (i) blade 36 is gradually flexed or bent due to inclined surface 72 having a relatively low slope and (ii) having blade 36 gradually bent or flexed allows blade 36 to be easily moved in the direction indicated by arrow 80 in a smooth controlled manner.

This is in contrast to attaching blade 36 to conventional blade handle 76. In particular, as shown in FIG. 13, blade 36 is already somewhat flexed and thus urged against conventional blade handle 76 (as described above in reference to FIG. 12) prior to moving blade 36 in the direction indicated by arrow 86. Therefore, moving blade 36 relative to conventional blade handle 76 in the direction indicated by arrow 86 (see FIG. 13) is relatively difficult as compared to moving blade 36 relative to blade handle 10 in the direction indicated by arrow 80 (see FIG. 7).

Referring now to FIG. 8, blade 36 is further moved relative to blade handle 10 in the direction indicated by arrow 80 until (i) trailing aperture edges 88 and 90 (see FIG. 11) are positioned with in grooves 32 and 33, respectively and (ii) trailing ramp end 54 extends through receiving aperture 42. Having trailing ramp end 54 extend through receiving aperture 42 locks blade 36 onto blade handle 10. Note that having trailing ramp end 54 extend through receiving aperture 42 results in leading edge 38 being positioned in contact with wall segment 66. Note that leading edge 38 (see FIG. 11) is configured to be angled relative to longitudinal axis 68 such that an angle is defined therebetween which is substantially equal to angle α.

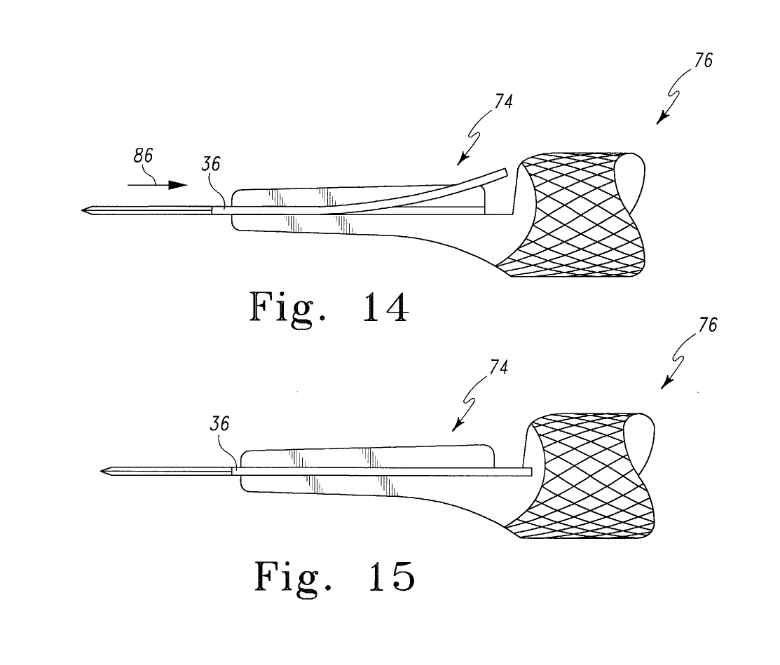

As shown in FIGS. 14 and 15, blade 36 can also be further moved relative to conventional blade handle 76 in the direction indicated by arrow 86. Moving blade 36 in this manner results in blade 36 being locked onto conventional blade handle 76. However, as discussed above, the movement of blade 36 in this manner is relatively difficult due to the aforementioned bending of blade 36.

Referring to FIGS. 7 and 8, removal of blade 36 from blade carrier member 14 is accomplished by bending or flexing end 70 of blade 36 in the direction indicated by arrow 92 until trailing ramp end 54 is no longer positioned within receiving aperture 42 (see FIG. 7). Thereafter, blade 36 is moved relative to blade carrier member 14 in the direction indicated by arrow 94. Note that as blade 36 is moved in the direction indicated by arrow 94 the degree blade 36 is flexed or bent gradually decreases as a result of sliding on inclined surface 72 of ramp portion 28 in the direction of from trailing ramp end 54 to leading ramp end 52. Gradually decreasing the degree blade 36 is flexed or bent progressively decreases the force blade 36 is urged against blade carrier member 14, which in turn enhances the ability of blade 36 to be easily removed from blade carrier member 14, and thus blade handle 10. Once again this is in contrast to many conventional blade handles, e.g. conventional blade handle 76, since the configuration of these handles results in the degree the blade is bent or flexed remaining substantially constant during the removal process. Having the blade constantly bent or flexed results in the blade being continually urged against the conventional blade handle, which in turn decreases the ability of blade 36 to be easily removed from the conventional blade handle.

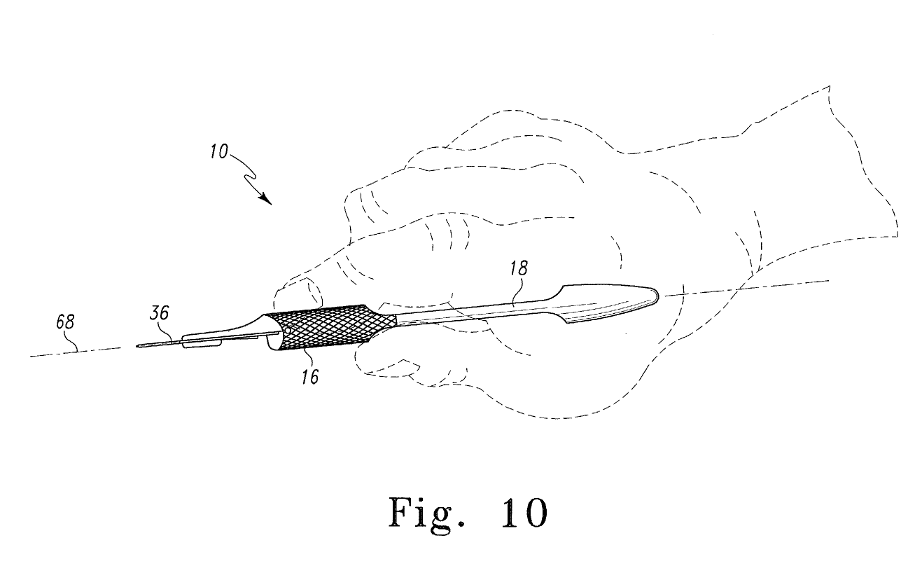

Now turning to FIGS. 9 and 10, it should be appreciated that the orientation of plate segment 18 corresponds to the orientation of blade 36. For example, as shown in FIG. 9, when plate segment 18 is located in a first orientation blade 36 is also located in the first orientation. On the other hand, as shown in FIG. 10, when plate segment 18 is located in a second orientation blade 36 is also located in the second orientation. Moreover, it should be appreciated that regardless of the orientation of plate segment 18 relative to blade 36, it can always be utilized to determine the orientation of blade 36. Thus having plate segment 18 extend from cylindrical gripping portion 16 in the above described manner provides a tactual reference point, and thus enhances a surgeon's ability to determine the orientation of blade 36 during a deep cut when blade 36 is out of the surgeon's field of view. In particular, a surgeon can make a tactual determination of the orientation of plate segment 18 (e.g. in a vertical or horizontal orientation) and thereby determine the orientation of blade 36 relative to plate segment 18.

Moreover, it should be appreciated that plate segment 18 can be positioned in other orientations relative to blade 36 and still function to tactually inform the surgeon as to the relative orientation of blade 36. For example, while FIGS. 9 and 10 show blade 36 and plate segment 18 being substantially aligned in a common plane, it is contemplated, for example, that plate segment 18 could be rotated 900 relative to blade 36 and still function to tactually inform the surgeon as to the relative orientation of blade 36.

Furthermore, it should be appreciated that cylindrical gripping portion 16 enhances a surgeon's ability to make circular or curved incisions because, as compared to a flat or plate like gripping portion, a surgeon can more easily rotate blade handle 10 around longitudinal axis 68 with his or her fingers while grasping cylindrical gripping portion 16. For example, as shown in FIG. 9, a surgeon can utilize his or her fingers to rotate blade handle 10 around longitudinal axis 68 in the direction indicated by arrow 96 or in the direction indicated by arrow 98. Therefore, it should be appreciated that cylindrical gripping portion 16 cooperates with plate segment 18 so as to provide a blade handle which facilitates a surgeon's ability to make circular or curved incisions while still allowing the surgeon to tactually determine the orientation of the blade relative to the handle.

While the invention has been illustrated and described in detail in the drawings and foregoing description, such an illustration and description is to be considered as exemplary and not restrictive in character, it being understood that only illustrative embodiments have been shown and described and that all changes and modifications that come within the spirit of the invention are desired to be protected.

There are a plurality of advantages of the present invention arising from the various features of the blade handle described herein. It will be noted that alternative embodiments of the blade handle of the present invention may not include all of the features described yet still benefit from at least some of the advantages of such features. Those of ordinary skill in the art may readily devise their own implementations of a blade handle that incorporates one or more of the features of the present invention and fall within the spirit and scope of the present invention as defined by the appended claims.

What is claimed is:

1. A blade handle, comprising:
a handle body;
a blade carrier member extending from an end of said handle body;
a shoulder member extending from a surface of said blade carrier member; and
a ramp portion extending from said surface of said blade carrier member, said ramp portion having a leading ramp end and a trailing ramp end, said ramp portion being positioned on said surface so that said leading ramp end contacts said shoulder member.

2. The blade handle of claim 1, wherein:
said handle body includes (i) a cylindrical gripping portion having an outer surface, a first end portion, and a second end portion and (ii) a plate segment,
said blade carrier member extends from said first end portion of said cylindrical gripping portion, and
said plate segment extends from said second end portion of said cylindrical gripping portion.

3. The blade handle of claim 1, further comprising:
a detent attached to an outer surface of said handle body such that said detent extends outwardly from said outer surface.

4. The blade handle of claim 2, wherein:
a channel is defined between said trailing ramp end and a wall segment defined on said first end portion of said cylindrical gripping portion, and
said wall segment intersects a longitudinal axis of said handle body so as to define an obtuse angle α.

5. The blade handle of claim 4, wherein:
said angle αis about 120° degrees.

6. The blade handle of claim 2, wherein:
said outer surface of said cylindrical gripping portion is textured.

7. A blade handle, comprising:
a blade carrier member; and
a handle body which includes (i) a cylindrical gripping portion having a first end portion and a second end portion and (ii) a plate segment,
wherein (i) said blade carrier member extends from said first end portion of said cylindrical gripping portion and (ii) said plate segment extends from said second end portion of said cylindrical gripping portion.

8. The blade handle of claim 7, further comprising:
a shoulder member extending from a surface of said blade carrier member; and
a ramp portion extending from said surface of said blade carrier member,
wherein (i) said ramp portion has a leading ramp end and a trailing ramp end and (ii) said ramp portion is positioned relative to said shoulder member so that said leading ramp end contacts said shoulder member.

9. The blade handle of claim 7, further comprising:
a detent attached to an outer surface of said handle body such that said detent extends outwardly from said outer surface.

10. The blade handle of claim 8, wherein:
a channel is defined between said trailing ramp end and a wall segment defined on said first end portion of said cylindrical gripping portion, and
said wall segment intersects a longitudinal axis of said handle body so as to define an obtuse angle α.

11. The blade handle of claim 10, wherein:
said angle α is about 120 degrees.

12. The blade handle of claim 7, wherein:
said cylindrical gripping portion has an outer surface, and
said outer surface is textured.

13. A blade handle, comprising:
a cylindrical gripping portion having a first end portion and a second end portion;
a blade carrier member attached to said first end portion of said cylindrical gripping portion, said blade carrier member having (i) a surface, (ii) a shoulder member extending outwardly from said surface, and (iii) a ramp portion extending outwardly from said surface, said ramp portion having a leading ramp end and a trailing ramp end, said ramp portion being positioned on said surface so that said leading ramp end contacts said shoulder member; and
a plate segment extending from said second end portion of said cylindrical gripping member.

14. The blade handle of claim 13, further comprising:
a detent attached to an outer surface of said handle body such that said detent extends outwardly from said outer surface.

15. The blade handle of claim 13, wherein:
a channel is defined between said trailing ramp end and a wall segment defined on said first end portion of said cylindrical gripping portion, and
said wall segment intersects a longitudinal axis of said handle body so as to define an obtuse angle α.

16. The blade handle of claim 15, wherein:
said angle α is about 120° degrees.

17. The blade handle of claim 13, wherein:
said cylindrical gripping portion has an outer surface, and
said outer surface is textured.
